(19) United States
(12) Patent Application Publication
(10) Pub. No.: US 2016/0023705 A1
(43) Pub. Date: Jan. 28, 2016

(54) DEVICE FOR COVERING AND SECURING ITEMS OR ARTICLES TO A TWO OR THREE-WHEELED VEHICLE

(71) Applicant: Victor Monge, Bronx, NY (US)

(72) Inventor: Victor Monge, Bronx, NY (US)

(21) Appl. No.: 14/700,443

(22) Filed: Apr. 30, 2015

Related U.S. Application Data
(60) Provisional application No. 61/986,300, filed on Apr. 30, 2014.

(51) Int. Cl. B62J 9/00

(52) U.S. Cl. CPC B62J 9/006

(57) ABSTRACT

The present invention relates to devices for securing and covering items or articles, particularly for securing and covering items or articles to two or three-wheeled vehicles, such as a motorcycle, or bicycle. The present invention is either shaped in order to secure and cover certain items or articles, including a helmet, such as a motorcycle helmet, and a baseball or similar cap, or is shaped in the form of a bag, such as a pack. The present invention secures and covers such items or articles by utilizing a number of different components, including fabric(s) and strap(s). In addition, the present invention is designed to be stored within certain portions of a two or three-wheeled vehicle, such as the compartment of a motorcycle, the frame of a bicycle, and the like.

### CROSS-REFERENCE TO RELATED APPLICATIONS

This application claims the benefit of U.S. Provisional Patent Application No. 61/986,300, filed Apr. 30, 2014.

### BACKGROUND OF THE INVENTION

The invention is in the field of devices for covering and securing items or articles, more particularly, in the field of devices for covering and securing items or articles to a two or three-wheeled vehicle.

Throughout the years there have been various types of devices for securing and covering items or articles. However, due to the increased usage of two and three-wheeled vehicles by travelers, exercise enthusiasts, commuters, and the like, there is a need for better improved carrying devices, such as the present invention.

### SUMMARY OF THE INVENTION

In one embodiment of the present invention, a device for covering and securing items or articles to a two or three-wheeled vehicle can comprise at least one of the following: at least one piece of material having two sides, at least one strap having at least two ends, at least one attaching device, at least one open/close device; and/or at least one opening of a size large enough to fit at least one of a helmet, motorcycle helmet, or baseball cap through said opening.

In another embodiment of the present invention, the at least one strap can comprise at least one of bungee cord, paracord, string, rope, cord, elastic, fabric, cloth, cotton, nylon, rubber, leather, and/or pliable material. The at least one strap having at least two ends can be at least two straps each having at least two ends, wherein the first end and/or the second end of each of said at least two straps each having at least two ends can be at least one of sewn to the at least one piece of material, connected via attaching device to the at least one piece of material, and/or is an attaching device. The at least one attaching device and/or at least one open/close device can comprise at least one of the following, in whole or in part: hook and loop, magnetic, Velcro®, snaps, buttons, male and female attaching parts, zippers, clips, strap and tightening, and/or strap and locking device. The at least one open/close device can be sewn and/or connected to the at least one piece of material. The at least one piece of material can be comprised of at least one of the following types of material: terrycloth, cotton, micro fiber, neoprene, nylon, denim, leather, elastic, vinyl, foam, plastic, polyester, spandex, fabric, rubber, and/or pliable material. The at least one piece of material can be at least one of weatherproof, weather resistant, waterproof, and/or water resistant. The at least one piece of material can comprise a decorative pattern, logos, brands, designs, characters, slogans, words. The at least one piece of material can cover at least one of the exterior of a helmet, such as a motorcycle helmet, the exterior of a cap, such as a baseball cap, and/or the at least one piece of interior material. The at least one piece of material can be in the shape of a pack, such as a backpack, or bag. The first end and/or the second end of said at least one strap having at least two ends can be sewn, and/or connected via attaching device to the at least one piece of material.

In another embodiment of the present invention, the at least one piece of material can be at least two pieces of material, wherein at least one of the at least two pieces of material can be at least one interior piece of material and at least one of the at least two pieces of material can be at least one exterior piece of material. The at least one open/close device can be sewn and/or connected to at least one of the at least one exterior piece of material and/or at least one interior piece of material. The at least one exterior piece of material can be comprised of at least one of the following types of material: terrycloth, cotton, micro fiber, neoprene, nylon, denim, leather, elastic, vinyl, foam, plastic, polyester, spandex, fabric, rubber, and/or pliable material. The at least one exterior piece of material can be at least one of weatherproof, weather resistant, waterproof, and/or water resistant. The at least one exterior piece of material can comprise a decorative pattern, logos, brands, designs, characters, slogans, words. The at least one exterior piece of material can cover at least one of the exterior of a helmet, such as a motorcycle helmet, the exterior of a cap, such as a baseball cap, and/or the at least one piece of interior material. The at least one exterior piece of material can be in the shape of a pack, such as a backpack, or bag. The at least one interior piece of material can be comprised of at least one of the following: terrycloth, cotton, micro fiber, neoprene, nylon, denim, leather, elastic, vinyl, foam, plastic, polyester, spandex, fabric, rubber, pliable material, scratchproof material, and/or scratch resistant material. The at least one interior piece of material can be housed within the at least one exterior piece of material. The at least one interior piece of material can cover the exterior of a helmet, such as a motorcycle helmet, and/or the exterior of a cap, such as a baseball cap. The at least one interior piece of material can be in the shape of a pack, such as a backpack, or bag. The at least one interior piece of material and at least one exterior piece of material can be folded or molded to form the shape of a pack, such as a backpack, bag or container, which can be at least one of carried, carried via the at least one strap, and/or fit into a compartment of a motorcycle, under a seat, or within a frame.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF THE SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the present invention.

FIG. 1 is a view of the bottom of a motorcycle seat removed from the motorcycle with one embodiment of the present invention attached to the front side of the motorcycle seat by means of straps and attaching device.

FIG. 2 is a view of the bottom of a motorcycle seat removed from the motorcycle with one embodiment of the present invention attached to the front side of the motorcycle seat by means of straps.

FIG. 3 is a rear view of a motorcycle seat removed from the rear of a motorcycle with one embodiment of the present invention covering a baseball cap and attaching to the motorcycle seat by means of strap. Additionally, FIG. 3 is a view of an opening of one embodiment of the present invention being in a closed position by means of open/close device.

FIG. 4 is a side view of a motorcycle seat removed from the motorcycle with one embodiment of the present invention covering a baseball cap and attaching to the motorcycle seat by means of straps.

FIG. 5 is a front view of a motorcycle seat removed from the motorcycle with one embodiment of the present invention covering a baseball cap and attaching to the motorcycle seat by means of straps.

FIG. 6 is a top view of a motorcycle seat removed from the motorcycle with one embodiment of the present invention covering a baseball cap and attaching to the motorcycle seat by means of straps.

FIG. 7 is a side view of a motorcycle seat removed from the motorcycle with one embodiment of the present invention partially covering a baseball cap and attaching to the motorcycle seat by means of straps.

FIG. 8 is a side view of a motorcycle with one embodiment of the present invention covering a baseball cap and attaching to the motorcycle's seat by means of straps.

FIG. 9 is a side front view of a motorcycle with one embodiment of the present invention covering a baseball cap and attaching to the motorcycle's seat by means of straps. Additionally, FIG. 9 is a side front view of an opening of one embodiment of the present invention being in a closed position by means of open/close device.

FIG. 10 is a rear view of a motorcycle with one embodiment of the present invention covering a baseball cap and attaching to the motorcycle's seat by means of straps.

FIG. 11 is a side view of a motorcycle with one embodiment of the present invention covering a motorcycle helmet and attaching to the motorcycle's seat by means of straps.

FIG. 12 is a rear view of a motorcycle with one embodiment of the present invention covering a motorcycle helmet and attaching to the motorcycle's seat by means of straps. Additionally, FIG. 12 is a view of an opening of one embodiment of the present invention being in a closed position by means of open/close device, namely a zipper.

FIG. 13 is a side front view of a motorcycle with one embodiment of the present invention covering a motorcycle helmet and attaching to the motorcycle's seat by means of straps. Additionally, FIG. 13 is a side front view of an opening of one embodiment of the present invention being in a closed position by means of open/close device, namely a zipper.

FIG. 14 is a view of an interior side of one embodiment of the present invention.

FIG. 15 is a view of an interior side of one embodiment of the present invention partially folding over itself into the form of a bag.

FIG. 16 is a view of one embodiment of the present invention completely folded over itself into the form of a bag.

FIG. 17 is a top front view of a motorcycle with the rear seat of the motorcycle removed to reveal the motorcycle's compartment, which, in this FIG. 17 holds one embodiment of the present invention completely folded over itself into the form of a bag.

FIG. 18 is a top view of a motorcycle seat removed from the motorcycle with one embodiment of the present invention being in the shape of a pack and attaching to the motorcycle seat by means of straps.

FIG. 19 is a side view of a motorcycle seat removed from the motorcycle with one embodiment of the present invention being in the shape of a pack and attaching to the motorcycle seat by means of straps.

FIG. 20 is a side view of a motorcycle seat removed from the motorcycle with one embodiment of the present invention being in the shape of a pack and attaching to the motorcycle seat by means of straps.

FIG. 21 is a rear view of a motorcycle with one embodiment of the present invention being in the form of a pack and attaching to the motorcycle's seat by means of straps.

FIG. 22 is a top view of one embodiment of the present invention, which includes a pocket or pouch, covering a motorcycle helmet.

### DETAILED DESCRIPTION OF THE INVENTION

Detailed descriptions of particular embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

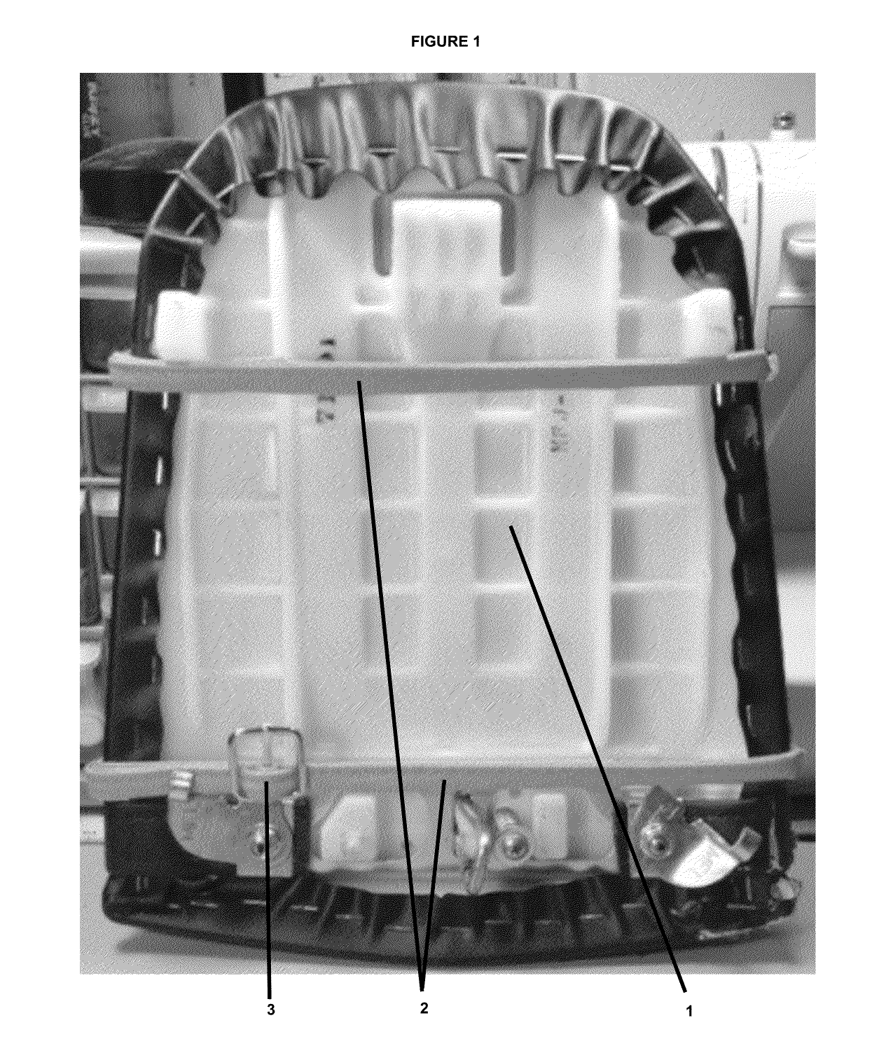

FIG. 1 is a view of the bottom of a motorcycle seat 1 removed from the motorcycle (not shown) with one embodiment of the present invention attached to the front side (not shown) of the motorcycle seat 1 by wrapping straps 2 around the back of the motorcycle seat 1 and using an attaching device 3.

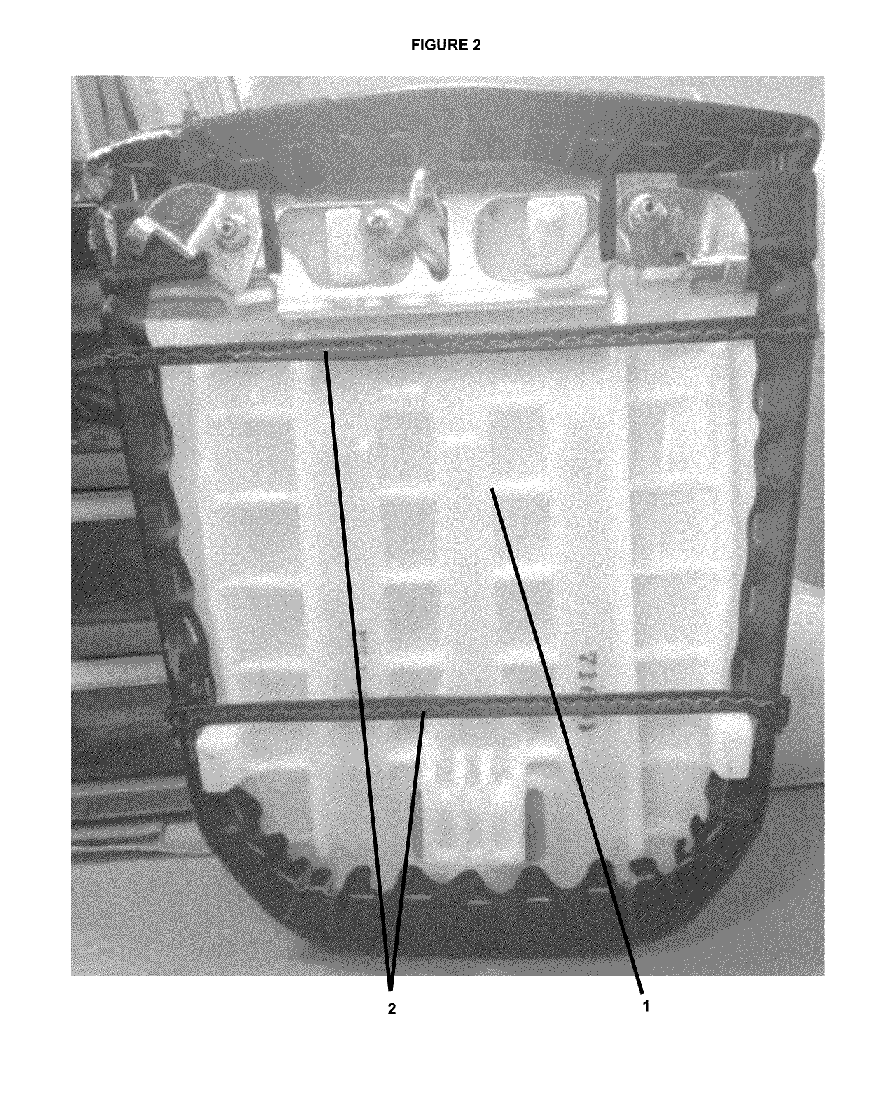

FIG. 2 is a view of the bottom of a motorcycle seat 1 removed from the motorcycle (not shown) with one embodiment of the present invention attached to the front side of the motorcycle seat 1 by means of straps 2 wrapping around the motorcycle seat 1.

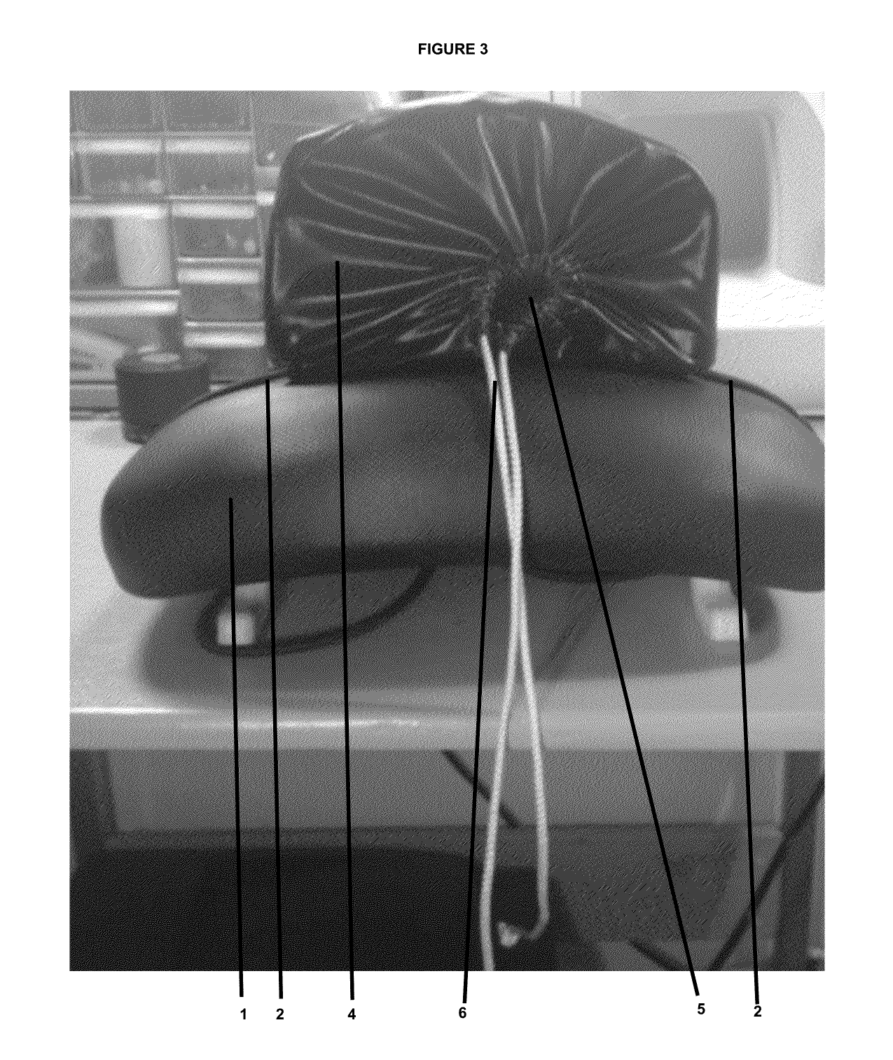

FIG. 3 is a rear view of a motorcycle seat 1 removed from the rear of a motorcycle (not shown) with at least one piece of material 4 covering a baseball cap and attaching to the motorcycle seat 1 by means of strap 2. Additionally, FIG. 3 shows an opening 5, and the at least one piece of material 4 being in a closed position by means of an open/close device 6, namely a cord.

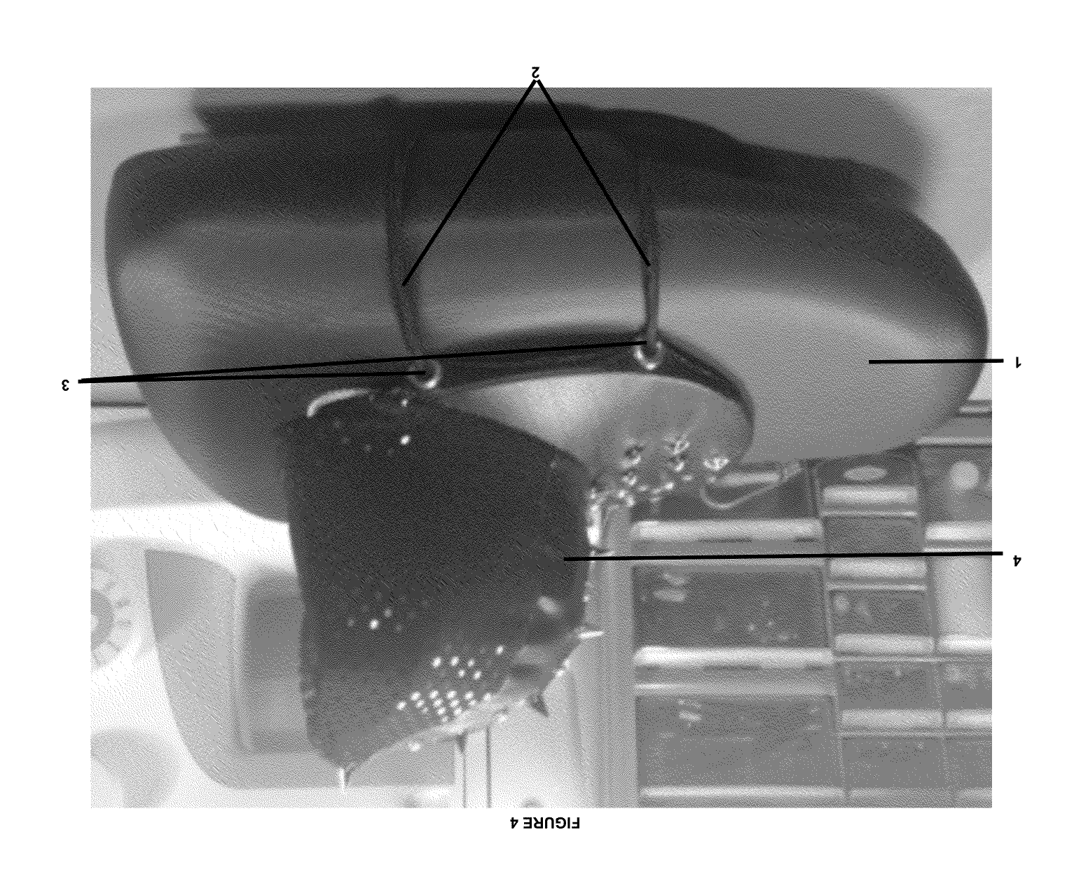

FIG. 4 is a side view of a motorcycle seat 1 removed from the motorcycle (not shown) with at least one piece of material 4 covering a baseball cap and attaching to the motorcycle seat 1 by means of straps 2. Additionally, FIG. 4 shows straps 2 attaching to at least one piece of material 4 via attaching device 3, namely a grommet.

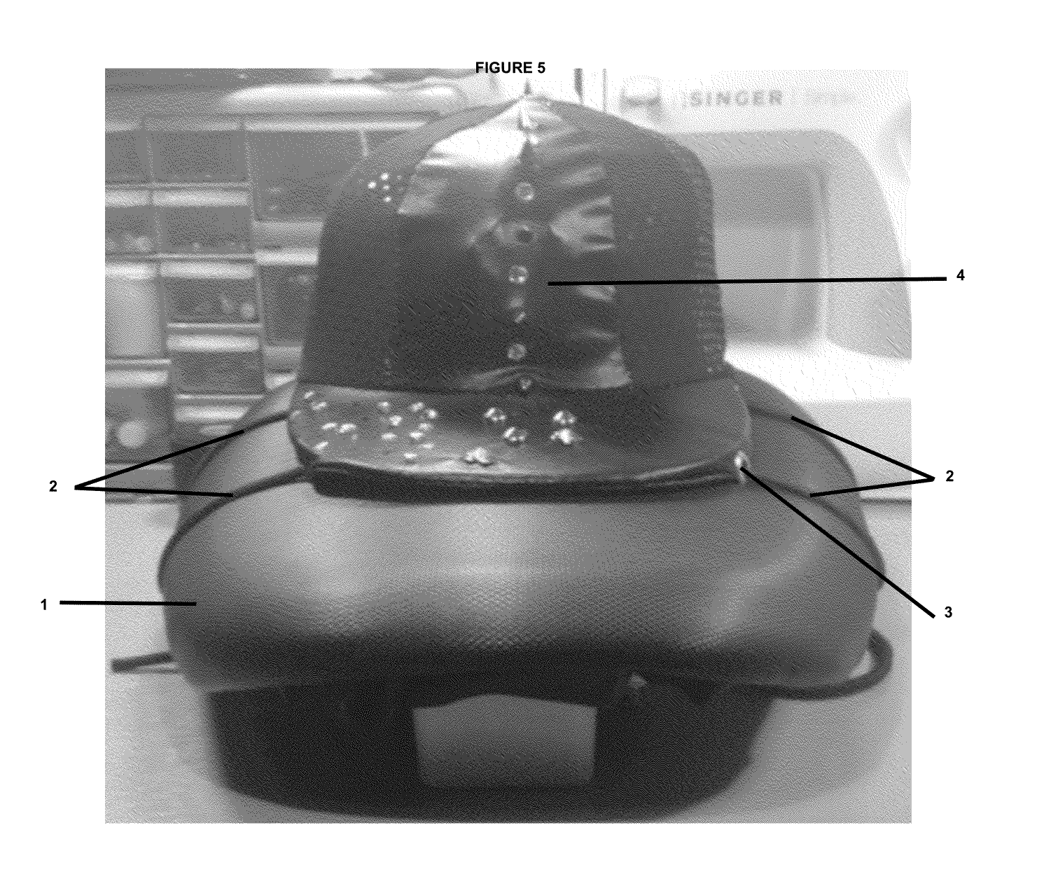

FIG. 5 is a front view of a motorcycle seat 1 removed from the motorcycle (not shown) with at least one piece of material 4 covering a baseball cap and attaching to the motorcycle seat 1 by means of straps 2. Additionally, FIG. 4 shows straps 2 attaching to at least one piece of material 4 via attaching device 3, namely a grommet.

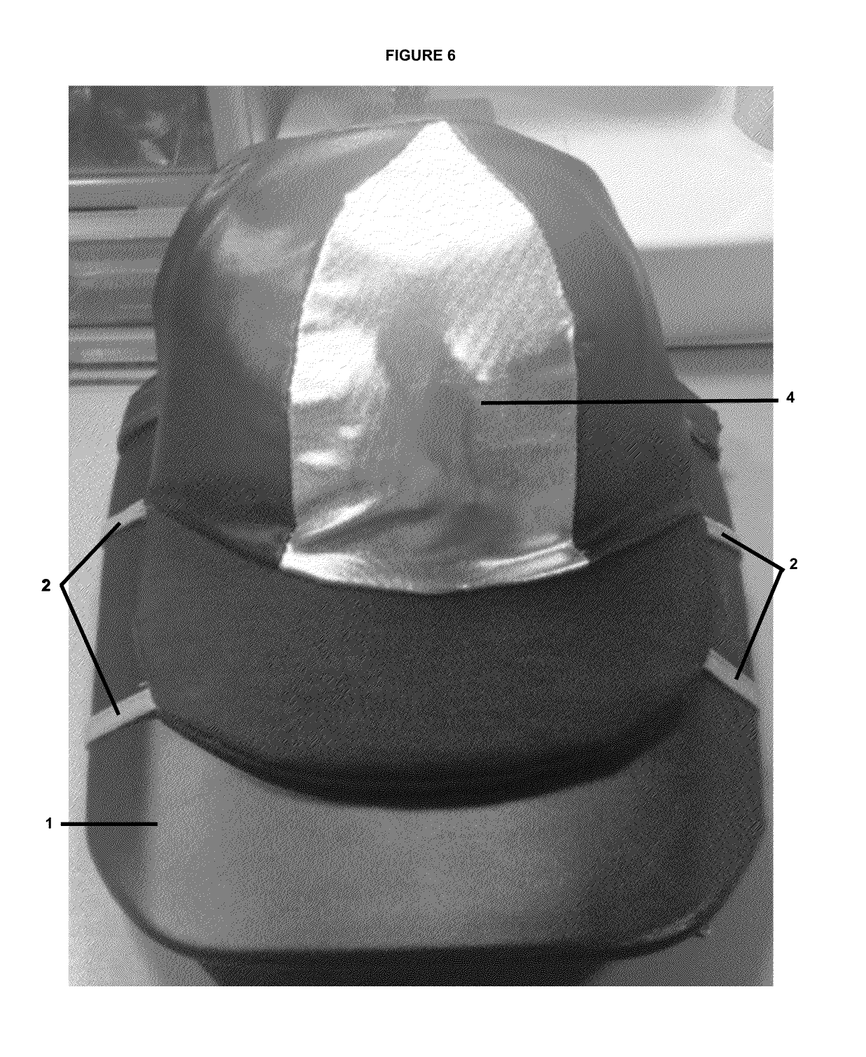

FIG. 6 is a top view of a motorcycle seat 1 removed from the motorcycle (not shown) with at least one piece of material 4 covering a baseball cap and attaching to the motorcycle seat 1 by means of straps 2.

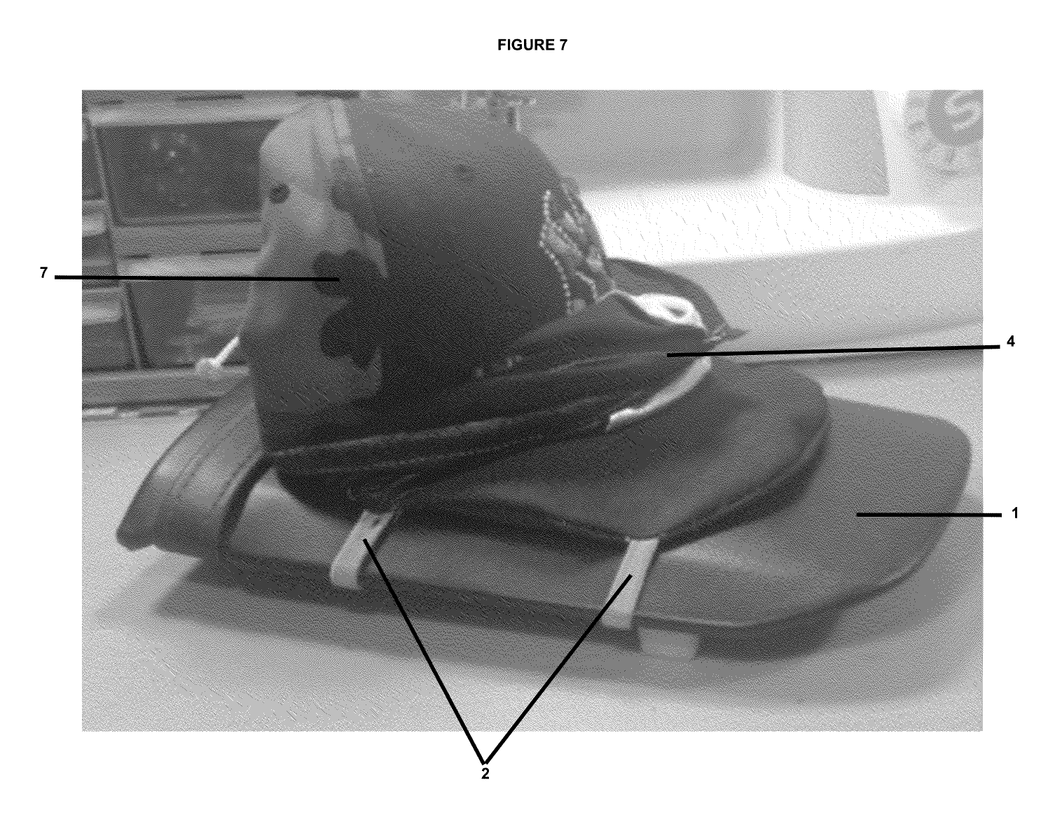

FIG. 7 is a side view of a motorcycle seat 1 removed from the motorcycle (not shown) with at least one piece of material 4 partially covering a baseball cap 7 and attaching to the motorcycle seat 1 by means of straps 2.

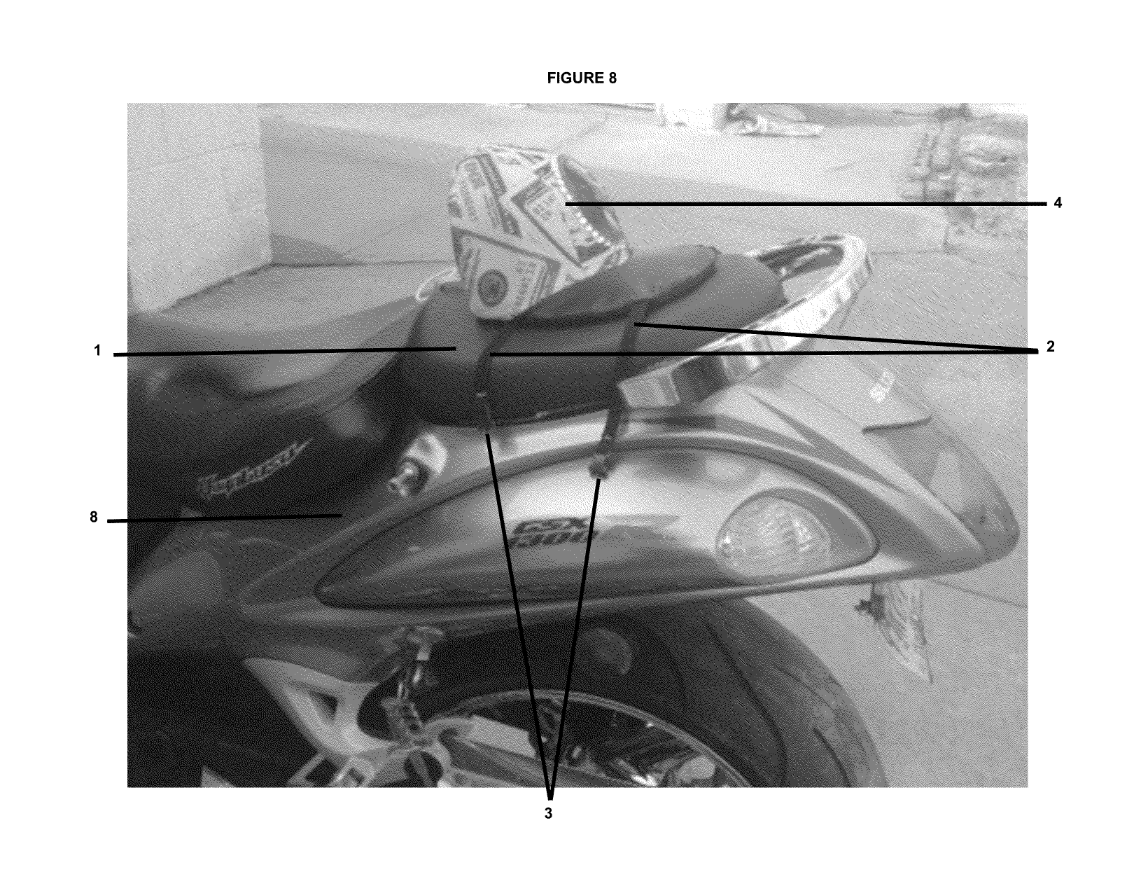

FIG. 8 is a side view of a motorcycle 8 with at least one piece of material 4 covering a baseball cap and attaching to the motorcycle's seat 1 by means of straps 2.

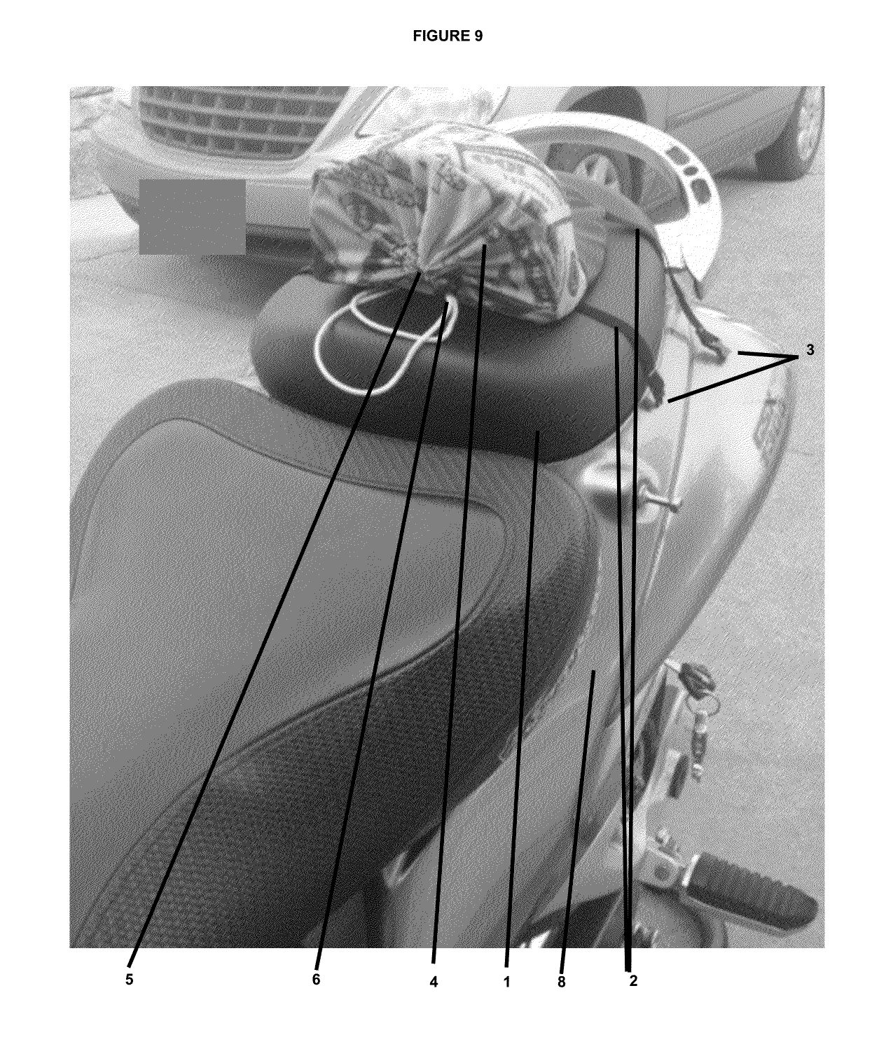

FIG. 9 is a side front view of a motorcycle 8 with at least one piece of material 4 covering a baseball cap and attaching to the motorcycle's seat 1 by means of straps 2. Additionally, FIG. 9 is a side front view of an opening 5 of one embodiment of the present invention being in a closed position by means of open/close device 6.

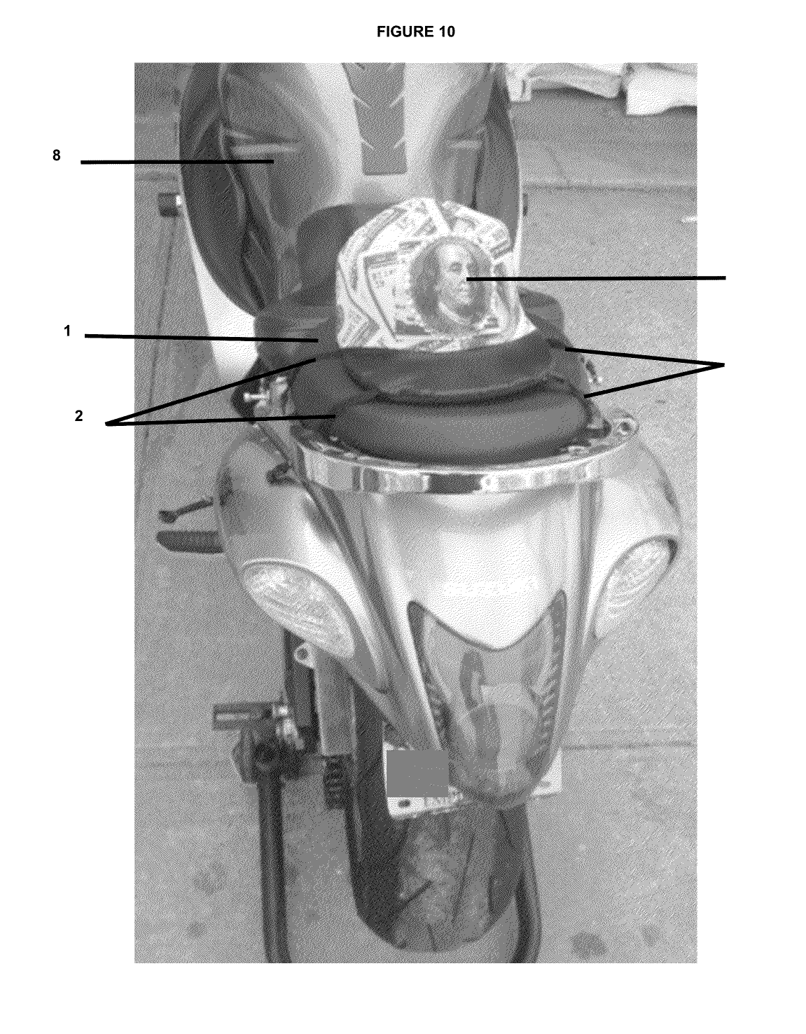

FIG. 10 is a rear view of a motorcycle 8 with at least one piece of material 4 covering a baseball cap and attaching to the motorcycle's seat 1 by means of straps 2.

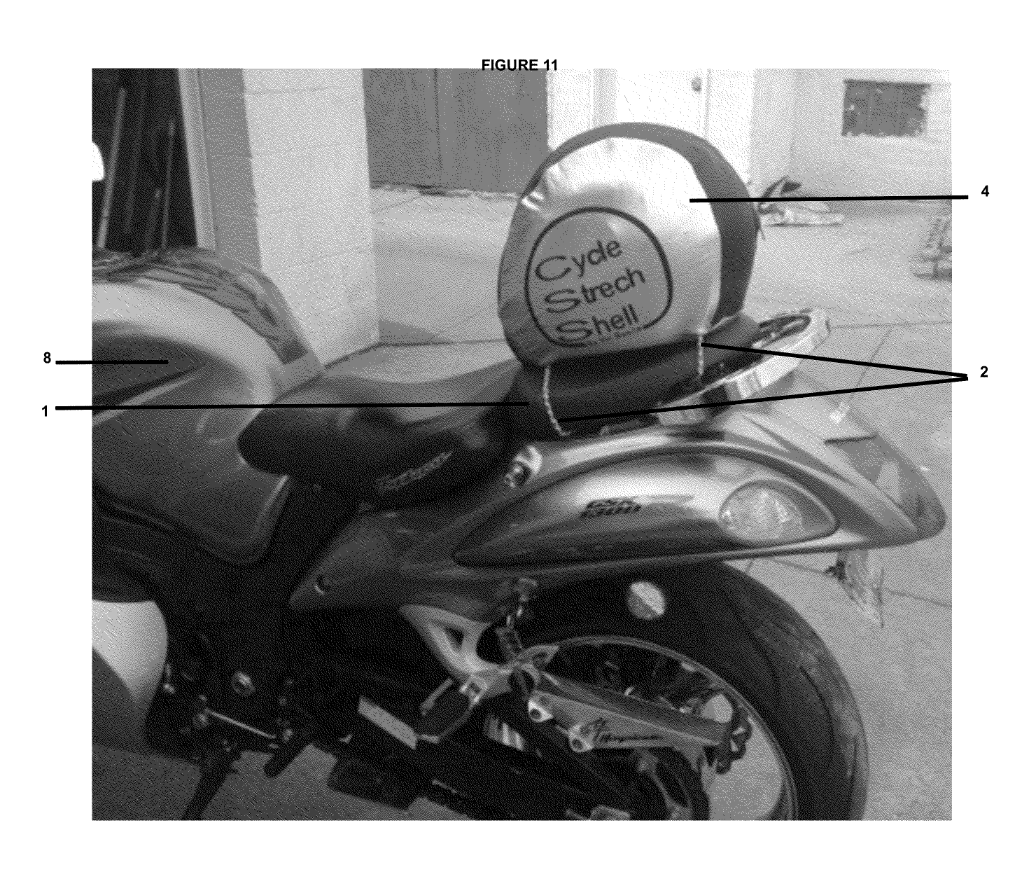

FIG. 11 is a side view of a motorcycle 8 with at least one piece of material 4 covering a motorcycle helmet and attaching to the motorcycle's seat 1 by means of straps 2.

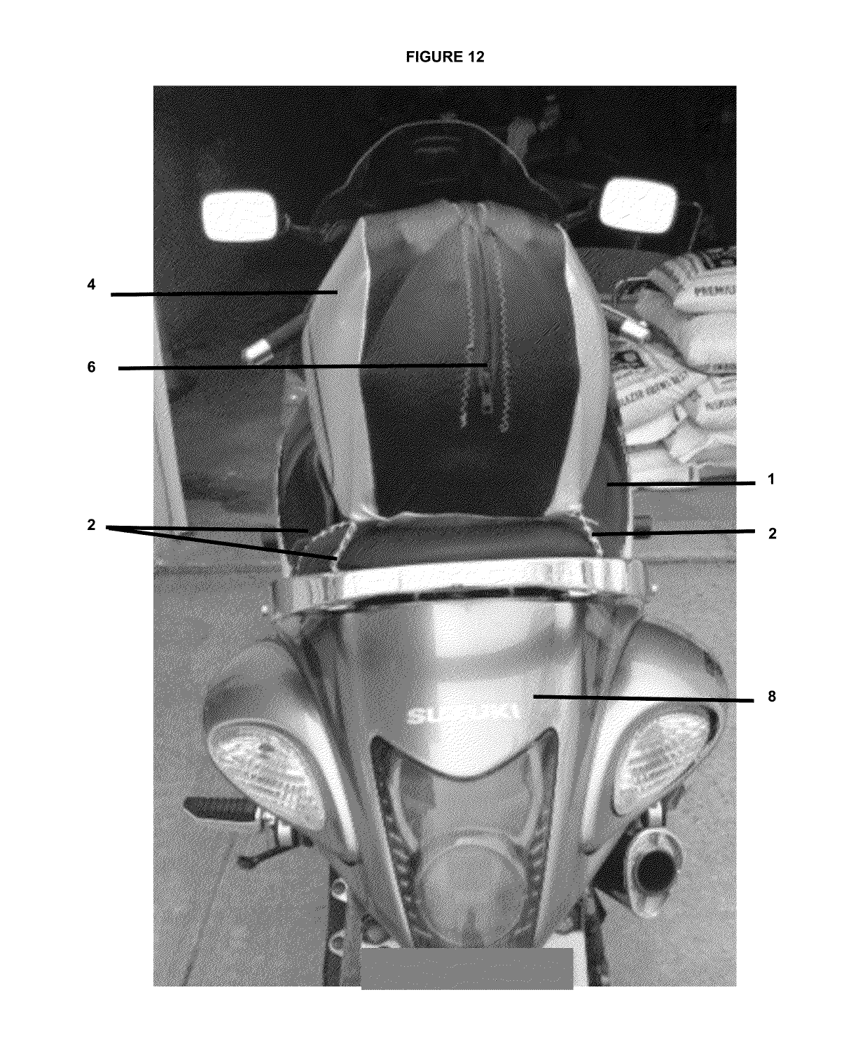

FIG. 12 is a rear view of a motorcycle 8 with at least one piece of material 4 covering a motorcycle helmet and attaching to the motorcycle's seat 1 by means of straps 2. Additionally, FIG. 12 is a view of an opening 5 of one embodiment of the present invention being in a closed position by means of open/close device 6, namely a zipper.

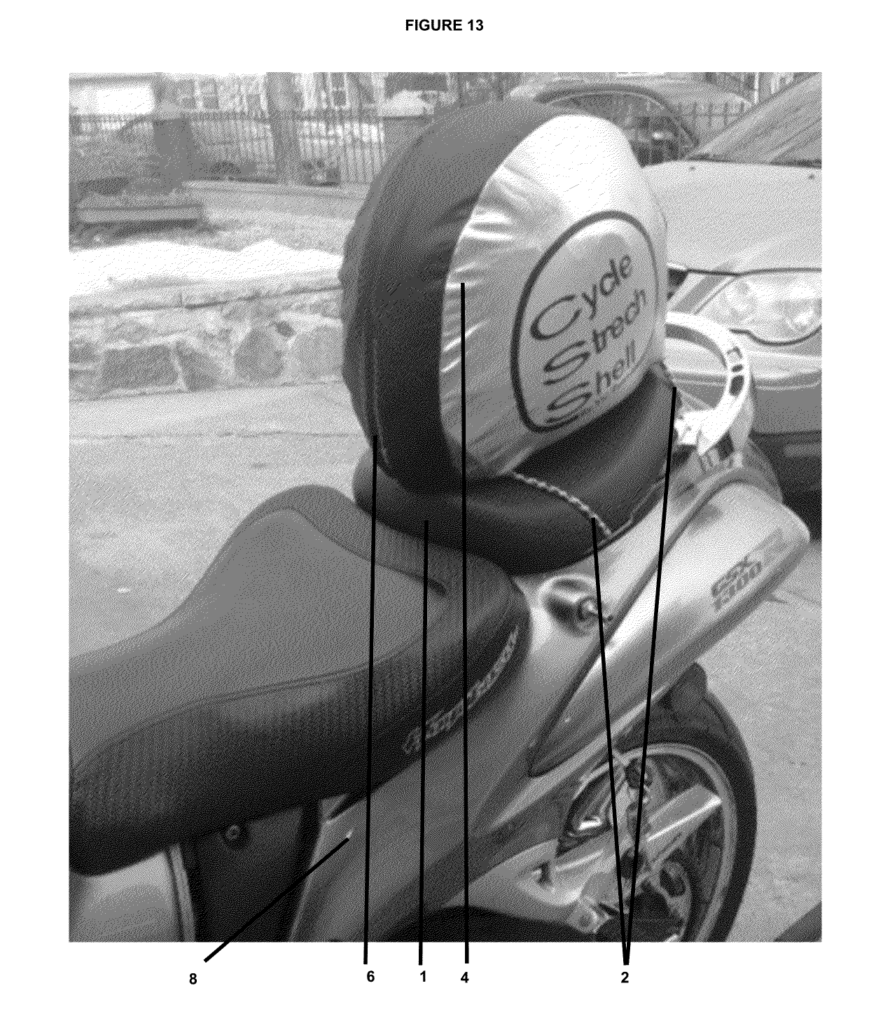

FIG. 13 is a side front view of a motorcycle 8 with at least one piece of material 4 covering a motorcycle helmet and attaching to the motorcycle's seat 1 by means of straps 2. Additionally, FIG. 13 is a side front view of an opening 5 of one embodiment of the present invention being in a closed position by means of open/close device 6, namely a zipper.

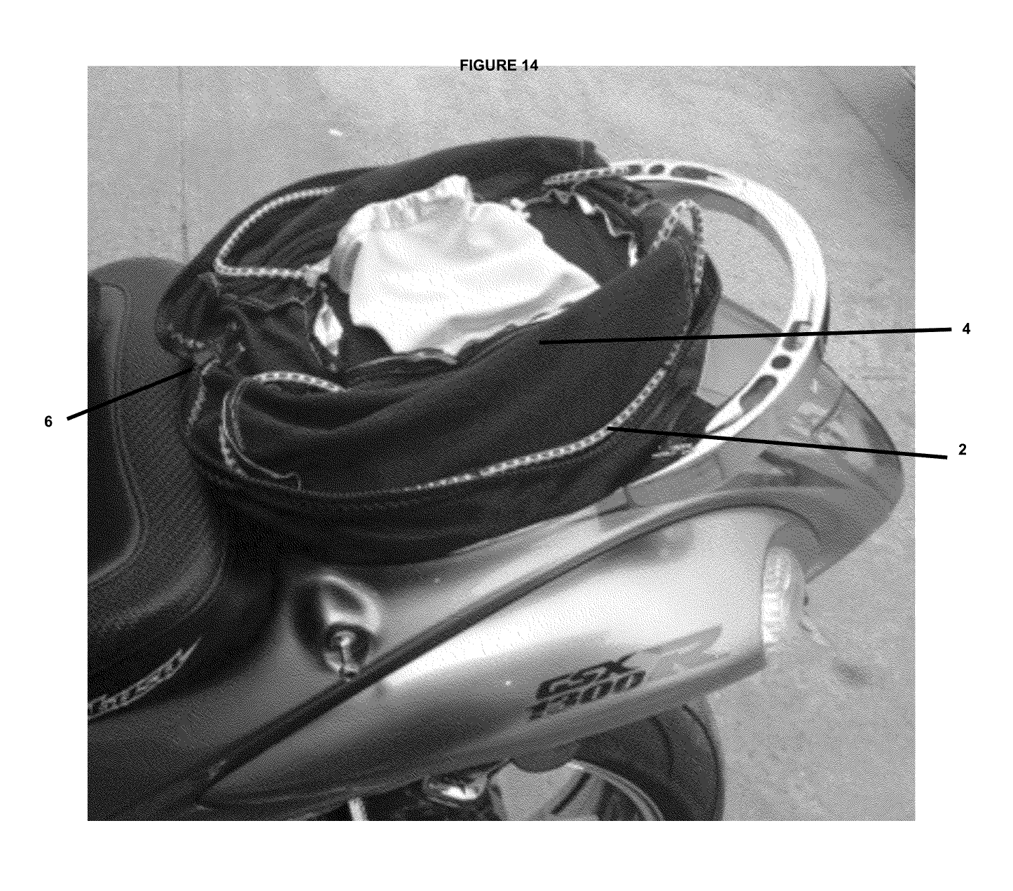

FIG. 14 is a view of an interior side of one embodiment of the present invention showing at least one piece of material 4, strap 2, and open/close device 6, namely a zipper.

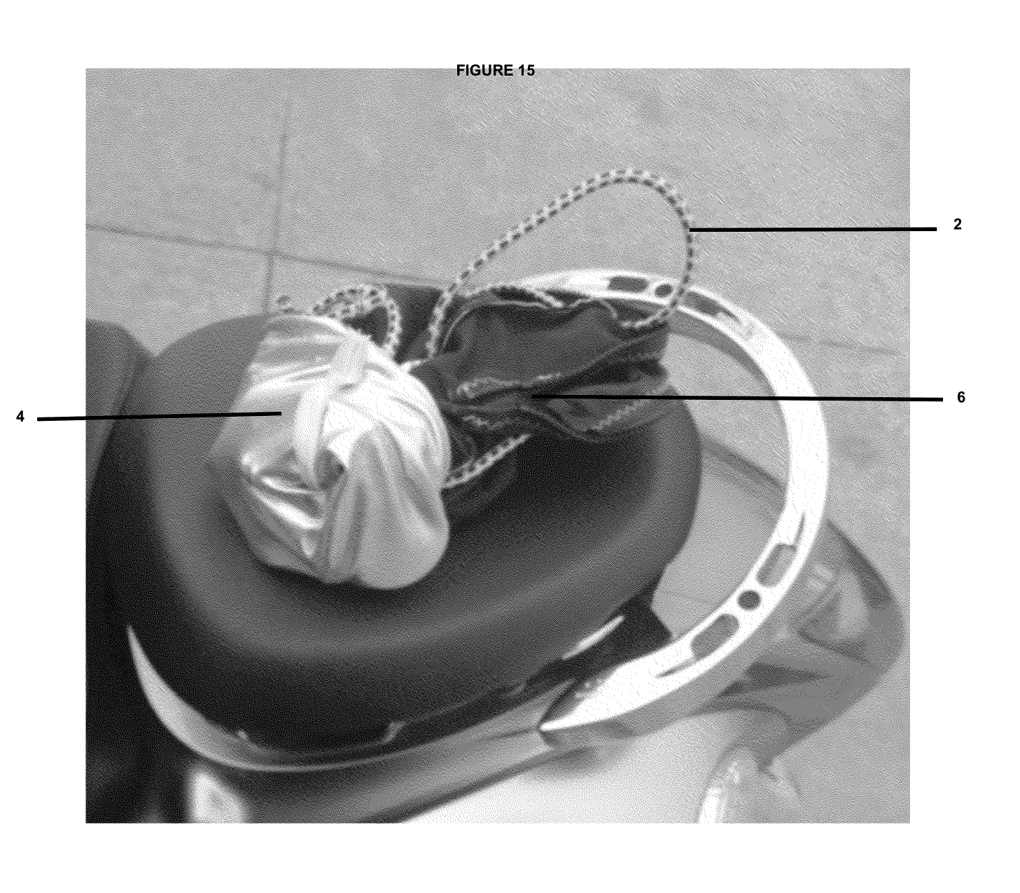

FIG. 15 is a view of an interior side of one embodiment of the present invention with at least one piece of material 4 partially folding over itself into the form of a bag. Additionally, FIG. 15 shows strap 2 sewn to the bottom side of at least one piece of material 4.

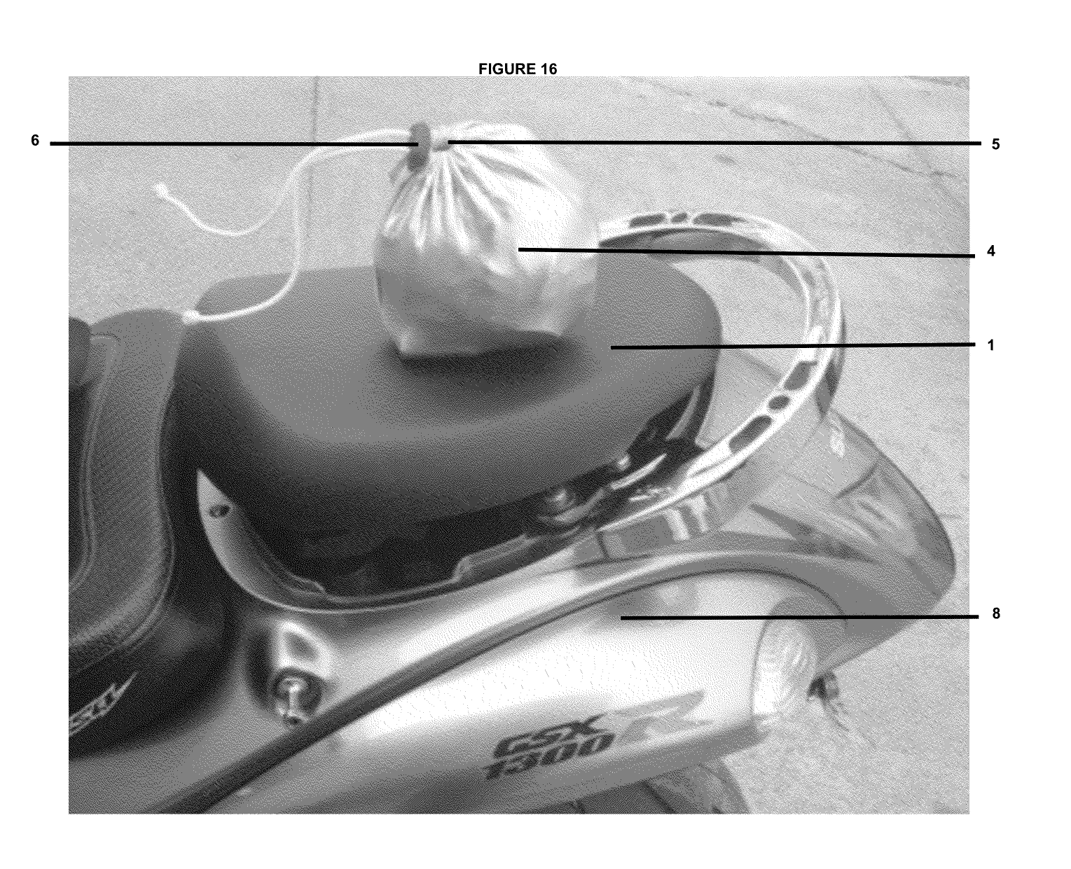

FIG. 16 is a view of one embodiment of the present invention with at least one piece of material 4 completely folded over itself into the form of a bag.

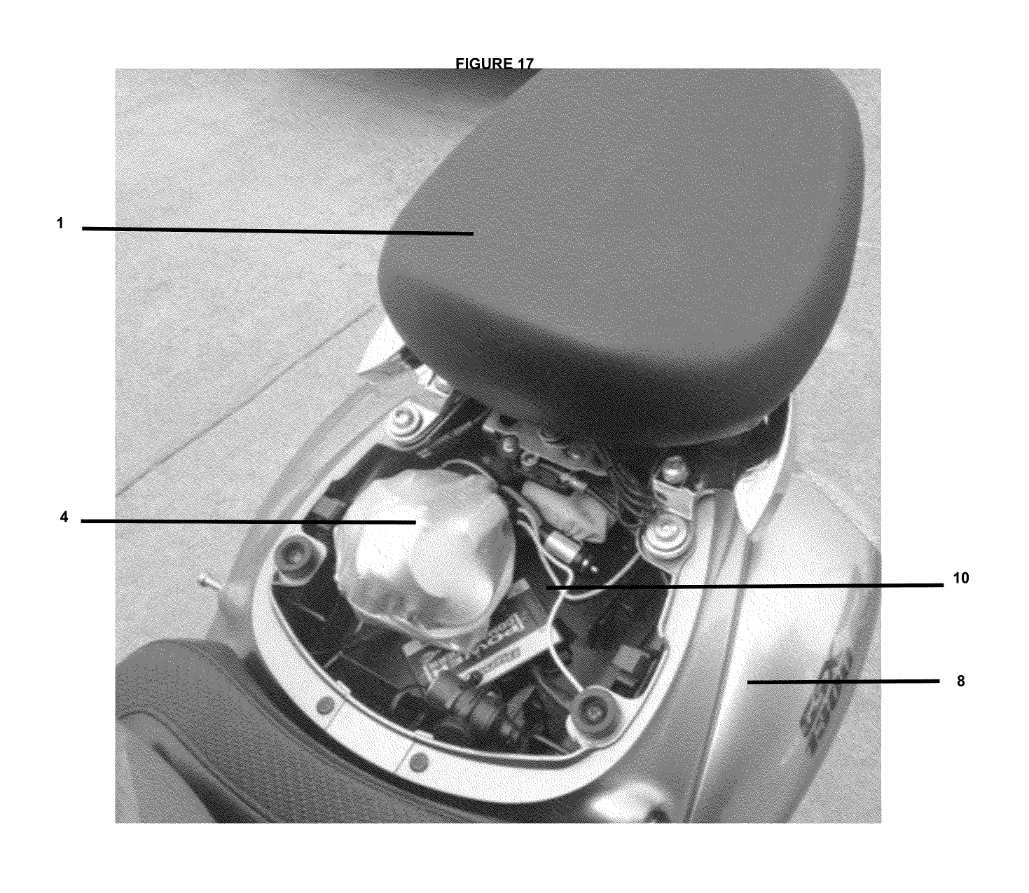

FIG. 17 is a top front view of a motorcycle 8 with the rear motorcycle seat 1 removed to reveal the motorcycle's compartment 10, which, in this FIG. 17 holds one embodiment of the present invention with at least one piece of material 4 completely folded over itself into the form of a bag.

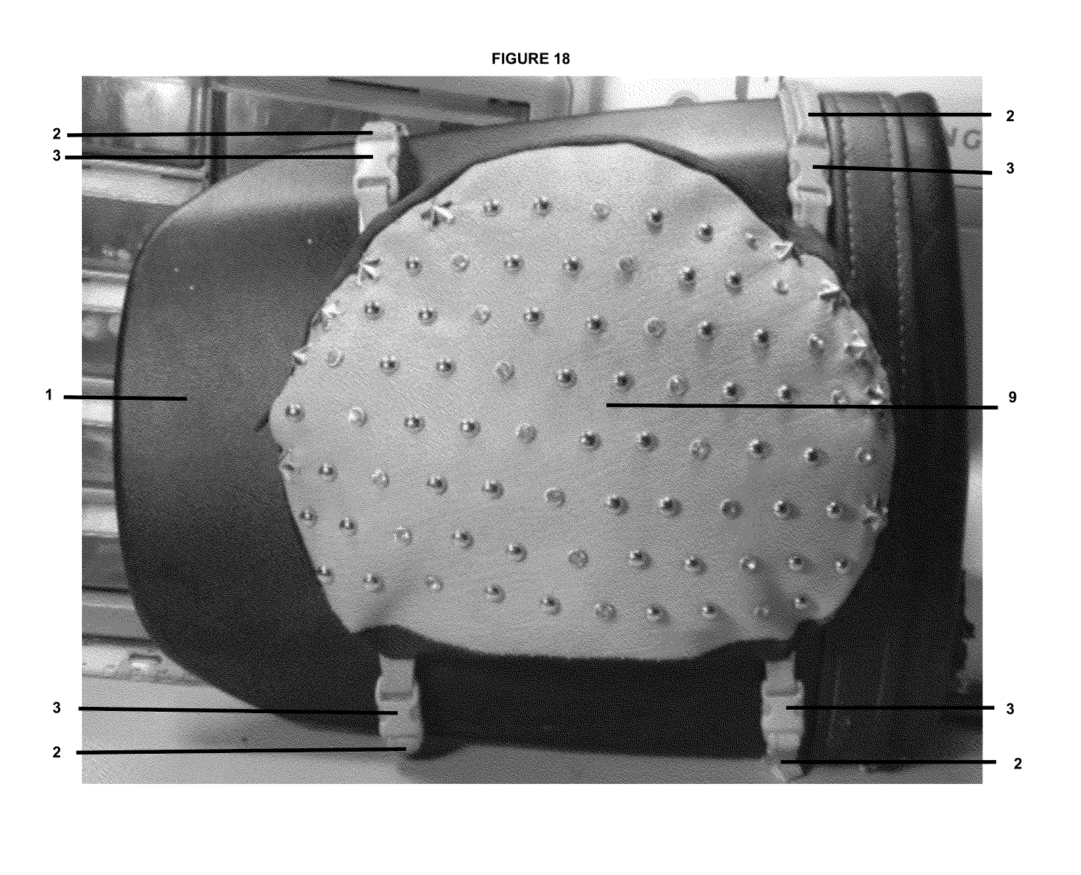

FIG. 18 is a top view of a motorcycle seat 1 removed from the motorcycle (not shown) with at least one piece of material being in the shape of a pack 9 and attaching to the motorcycle seat 1 by means of straps 2. Additionally, FIG. 18 shows pack 9 connecting to straps 2 by means of attaching device 3.

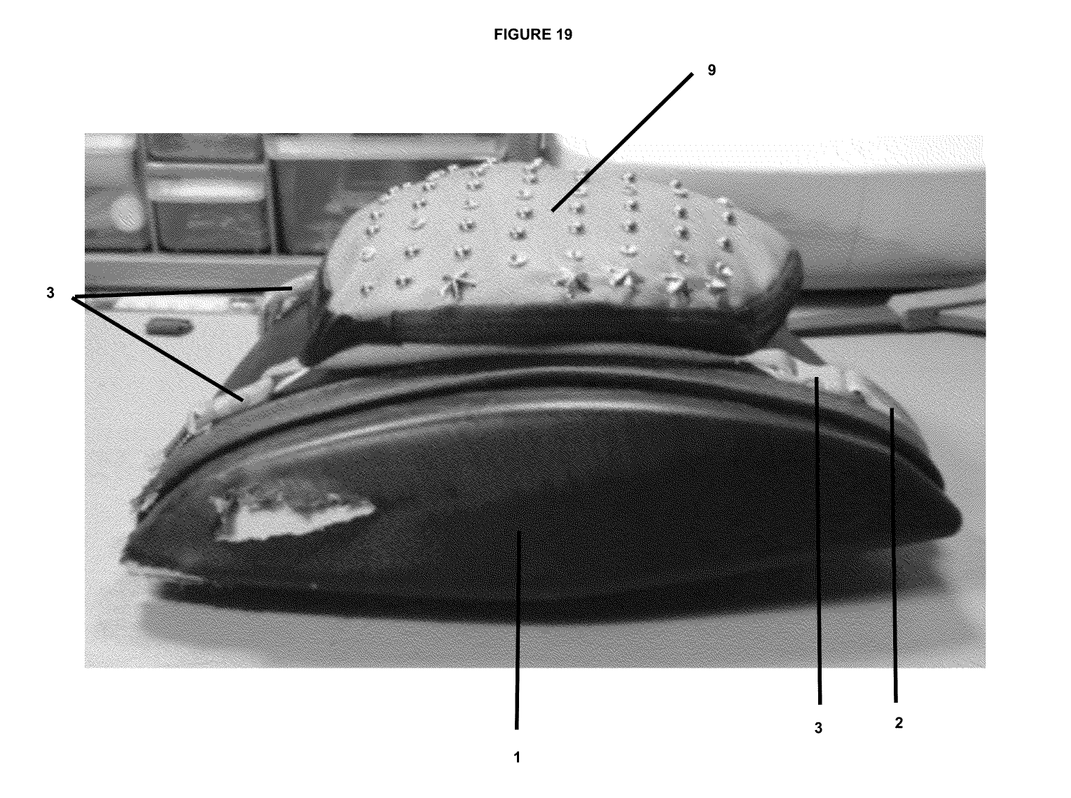

FIG. 19 is a side view of a motorcycle seat 1 removed from the motorcycle (not shown) with at least one piece of material being in the shape of a pack 9 and attaching to the motorcycle seat by means of straps 2. Additionally, FIG. 19 shows pack 9 connecting to straps 2 by means of attaching device 3.

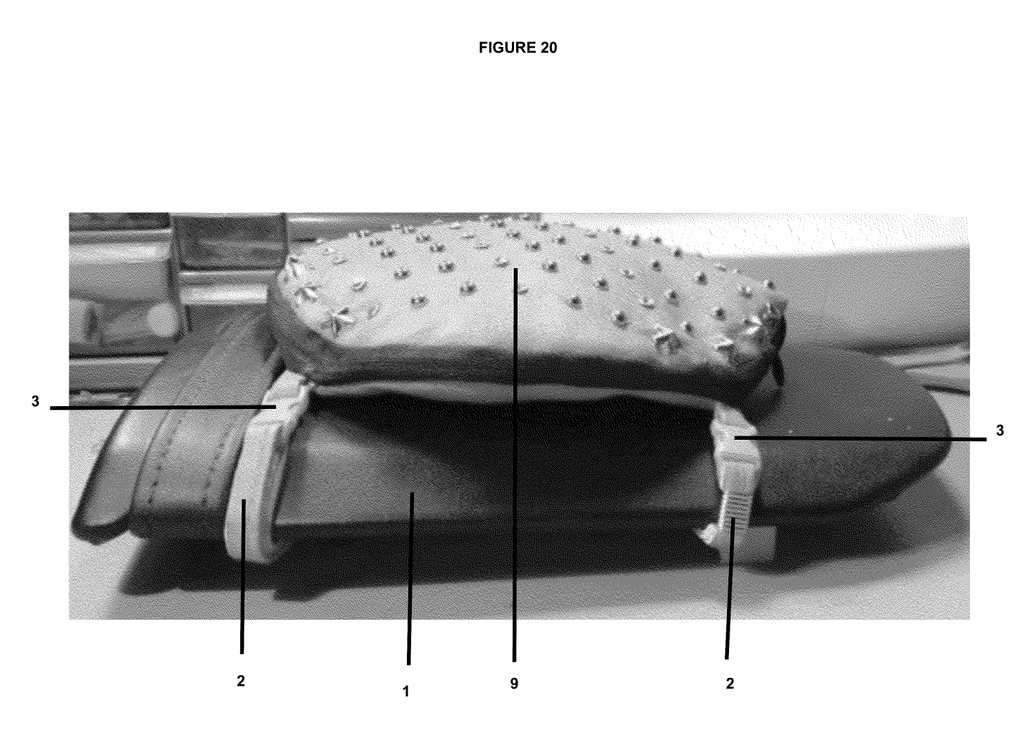

FIG. 20 is a side view of a motorcycle seat 1 removed from the motorcycle (not shown) with at least one piece of material being in the shape of a pack 9 and attaching to the motorcycle seat by means of straps 2. Additionally, FIG. 20 shows pack 9 connecting to straps 2 by means of attaching device 3.

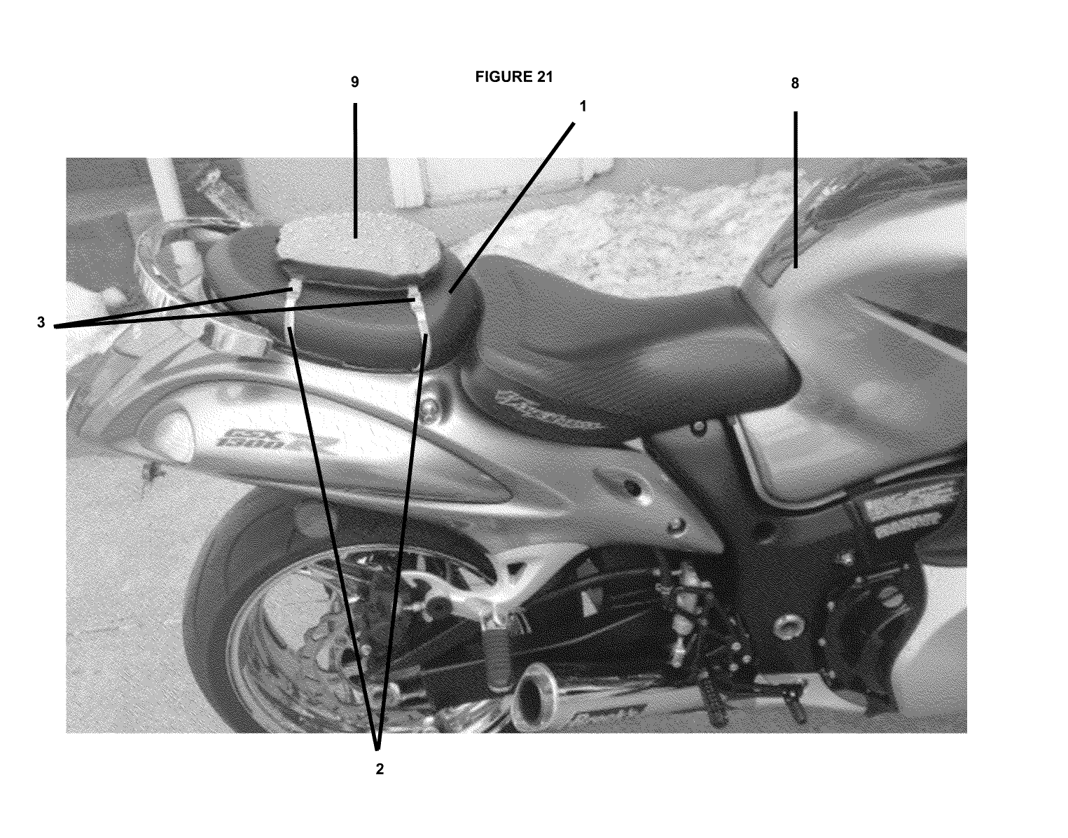

FIG. 21 is a rear view of a motorcycle 8 with at least one piece of material being in the form of a pack 9 and attaching to the motorcycle's seat 1 by means of straps 2. Additionally, FIG. 21 shows pack 9 connecting to straps 2 by means of attaching device 3.

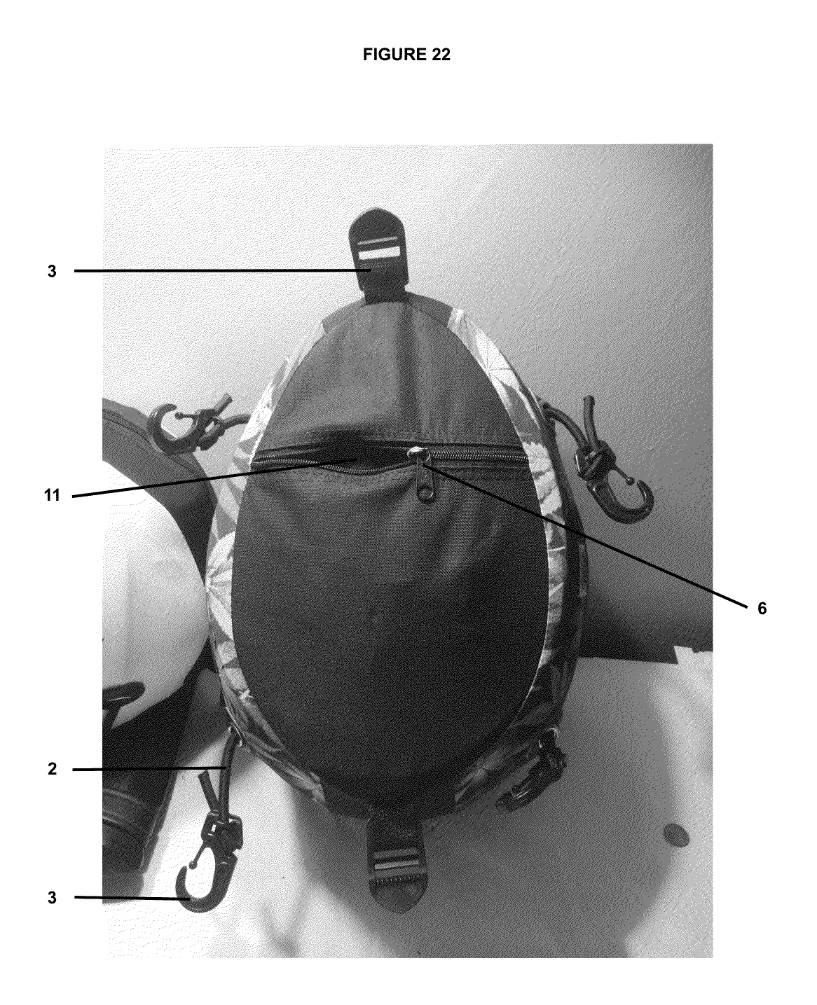

FIG. 22 is a top view of one embodiment of the present invention, which includes a pocket 11 that can be opened or closed by open/close device 6, covering a motorcycle helmet. Additionally, FIG. 22 shows straps 2 and attaching device 3 for connecting this embodiment of the present invention to a motorcycle or additional straps, and/or carrying said embodiment.

### COMPONENT LIST FOR DRAWINGS

Following is a partial list of the components depicted in the drawings:

| Component Number | Component Description |
|---|---|
| 1 | Motorcycle Seat |
| 2 | Strap(s) |
| 3 | Attaching Device |
| 4 | At least one piece of material |
| 5 | Opening |
| 6 | Open/Close Device |
| 7 | Baseball Cap |
| 8 | Motorcycle |
| 9 | Pack |
| 10 | Motorcycle Compartment |
| 11 | Pocket |

### DEFINITIONS

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

What is claimed:

1. A device for covering and securing items or articles to a two or three-wheeled vehicle comprising at least one of the following:
at least one piece of material having two sides;
at least one strap having at least two ends;
at least one attaching device;
at least one open/close device;
at least one pocket; and/or
at least one opening of a size large enough to fit at least one of the following items through said opening:
a helmet;
a motorcycle helmet; or
a baseball cap.

2. The device for covering and securing items or articles to a two or three-wheeled vehicle of claim 1 wherein said at least one strap comprises at least one of the following: bungee cord, paracord, string, rope, cord, elastic, fabric, cloth, cotton, nylon, rubber, leather, and/or pliable material.

3. The device for covering and securing items or articles to a two or three-wheeled vehicle of claim 1 wherein said at least one strap having at least two ends is at least two straps each having at least two ends.

4. The device for covering and securing items or articles to a two or three-wheeled vehicle of claim 1 wherein said at least one attaching device and/or at least one open/close device comprises at least one of the following, in whole or in part: hook and loop, magnetic, Velcro®, snaps, buttons, male and female attaching parts, zippers, clips, strap and tightening, and/or strap and locking device.

5. The device for covering and securing items or articles to a two or three-wheeled vehicle of claim 1 wherein said at least one open/close device is sewn and/or connected to the at least one piece of material.

6. The device for covering and securing items or articles to a two or three-wheeled vehicle of claim 1 wherein said at least one piece of material is at least one of the following:
comprised of at least one of the following types of material: terrycloth, cotton, micro fiber, neoprene, nylon, denim, leather, elastic, vinyl, foam, plastic, polyester, spandex, fabric, rubber, and/or pliable material;
at least one of weatherproof, weather resistant, waterproof, and/or water resistant;
comprises a decorative pattern, logos, brands, designs, characters, slogans, words;
covers at least one of the exterior of a helmet, such as a motorcycle helmet, the exterior of a cap, such as a baseball cap, and/or the at least one piece of interior material; and/or
in the shape of a pack, such as a backpack, or bag.

7. The device for covering and securing items or articles to a two or three-wheeled vehicle of claim 1 wherein the first end and/or the second end of said at least one strap having at least two ends is sewn, and/or connected via attaching device to the at least one piece of material.

8. The device for covering and securing items or articles to a two or three-wheeled vehicle of claim 1 wherein said at least one piece of material is at least two pieces of material, and wherein at least one of the at least two pieces of material is at least one interior piece of material and at least one of the at least two pieces of material is at least one exterior piece of material.

9. The device for covering and securing items or articles to a two or three-wheeled vehicle of claim 8 wherein said at least one open/close device is sewn and/or connected to at least one of the at least one exterior piece of material and/or at least one interior piece of material.

10. The device for covering and securing items or articles to a two or three-wheeled vehicle of claim 8 wherein said at least one exterior piece of material is at least one of the following:
comprised of at least one of the following types of material: terrycloth, cotton, micro fiber, neoprene, nylon, denim, leather, elastic, vinyl, foam, plastic, polyester, spandex, fabric, rubber, and/or pliable material;
at least one of weatherproof, weather resistant, waterproof, and/or water resistant;
comprises a decorative pattern, logos, brands, designs, characters, slogans, words;
covers at least one of the exterior of a helmet, such as a motorcycle helmet, the exterior of a cap, such as a baseball cap, and/or the at least one piece of interior material; and/or
in the shape of a pack, such as a backpack, or bag.

11. The device for covering and securing items or articles to a two or three-wheeled vehicle of claim 8 wherein said at least one interior piece of material is at least one of the following:
comprised of at least one of the following: terrycloth, cotton, micro fiber, neoprene, nylon, denim, leather, elastic, vinyl, foam, plastic, polyester, spandex, fabric, rubber, pliable material, scratchproof material, and/or scratch resistant material;
housed within the at least one exterior piece of material;
covers the exterior of a helmet, such as a motorcycle helmet, and/or the exterior of a cap, such as a baseball cap; and/or
is in the shape of a pack, such as a backpack, or bag.

12. The device for covering and securing items or articles to a two or three-wheeled vehicle of claim 8 wherein said at least one interior piece of material and at least one exterior piece of material is folded or molded to form the shape of a pack, such as a backpack, bag or container.

13. The device for covering and securing items or articles to a two or three-wheeled vehicle of claim 12 wherein said bag or container can be at least one of carried, carried via the at least one strap, and/or fit into a compartment of a motorcycle, under a seat, or within a frame.

14. The device for covering and securing items or articles to a two or three-wheeled vehicle of claim 3 wherein the first end and/or the second end of each of said at least two straps each having at least two ends is at least one of the following:
sewn to the at least one piece of material;
connected via attaching device to the at least one piece of material; and/or
is an attaching device.
